(19) United States
(12) Patent Application Publication
(10) Pub. No.: US 2018/0332537 A1
(43) Pub. Date: Nov. 15, 2018

(54) METHODS AND APPARATUS FOR INTELLIGENT MONITORING IN DISCOVERY PERIODS

(71) Applicant: QUALCOMM Incorporated, San Diego, CA (US)

(72) Inventors: Parthasarathy KRISHNAMOORTHY, San Diego, CA (US); Soumen MITRA, Hyderabad (IN); Priyangshu GHOSH, Kolkata (IN); Tushar GUPTA, Kanpur (IN); Ashish Shankar IYER, San Diego, CA (US); Marc AZAR, San Diego, CA (US); Muthukumaran DHANAPAL, San Diego, CA (US); Shravan Kumar RAGHUNATHAN, San Diego, CA (US)

(21) Appl. No.: 15/592,157

(22) Filed: May 10, 2017

(51) Int. Cl. H04W 52/02; H04W 8/00; H04W 76/02; H04W 24/08; H04W 64/00

(52) U.S. Cl. CPC H04W 52/0248; H04W 8/005; H04W 64/003; H04W 24/08; H04W 76/023

(57) ABSTRACT

Various features related to reducing power consumption by devices during discovery periods D2D communication system, are described. In an aspect, a transmission pattern learning based intelligent monitoring approach is used. In certain configurations, an apparatus, e.g., a UE, may be configured to monitor, during a first set of discovery periods, transmissions of a plurality of different PACs associated with different applications, and identify PACs of interest from the plurality of different PACs. In some configurations, the apparatus maybe further configured to identify, based on the monitoring, transmission patterns of the PACs of interest, and monitor, during a second set of discovery periods, transmissions corresponding to the PACs of interest based on the identified transmission patterns. In some configurations, the PACs of interest monitored during the second set of discovery periods may be a subset of the plurality of different PACs monitored during the first set of discovery periods.

### BACKGROUND

### Field

The present disclosure relates generally to communication systems, and more particularly, to methods and apparatus for intelligent monitoring, e.g., during discovery periods, based on transmission pattern learning and network feedback.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Currently available discovery procedures utilized in many device-to-device type communication systems for allowing discovery of devices and services of interest are not power efficient. A device may need to monitor a large number of time-frequency resources during a discovery phase. Therefore, there is a need for methods and apparatus that facilitate power efficient discovery.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Various features related to reducing power consumption by devices during discovery periods in a device-to-device (D2D) communication system, are described. In accordance with an aspect of the disclosure, a learning based intelligent monitoring approach to monitor limited number of time-frequency resources, during the discovery periods is used without compromising device and/or system performance. In an aspect, a device may monitor discovery resources to learn/identify transmission patterns different Proximity Service (ProSe) applications of interest (e.g., installed on the device) over a period of time. In some configurations, the learning based approach may be used in combination with a network feedback approach to further improve power savings during discovery periods.

In an aspect of the disclosure, a method, a computer-readable medium, and an apparatus are provided. The apparatus, e.g., a UE, may be configured to monitor, during a first set of discovery periods, transmissions of a plurality of different proximity service (ProSe) application codes (PACs) associated with different applications, and identify PACs of interest from the plurality of different PACs. In some configurations, the apparatus may be further configured to identify transmission patterns of the PACs of interest based on the monitoring. In some configurations, the apparatus may be further configured to monitor, during a second set of discovery periods, transmissions corresponding to the PACs of interest based on the identified transmission patterns. In some configurations, the PACs of interest monitored during the second set of discovery periods may be a subset of the plurality of different PACs monitored during the first set of discovery periods.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communication system and an access network.

FIGS. 2A, 2B, 2C, and 2D are diagrams illustrating examples of a DL frame structure, DL channels within the DL frame structure, an UL frame structure, and UL channels within the UL frame structure, respectively.

FIG. 3 is a diagram illustrating an example of a base station and user equipment (UE) in an access network.

FIG. 4 is a diagram of a device-to-device communication system.

FIG. 5 illustrates an exemplary communication system and a recurring time-frequency resource structure which may be used by devices in the communication system performing discovery.

FIG. 6 is a flowchart of a method of wireless communication.

FIG. 7 is a conceptual data flow diagram illustrating the data flow between different means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

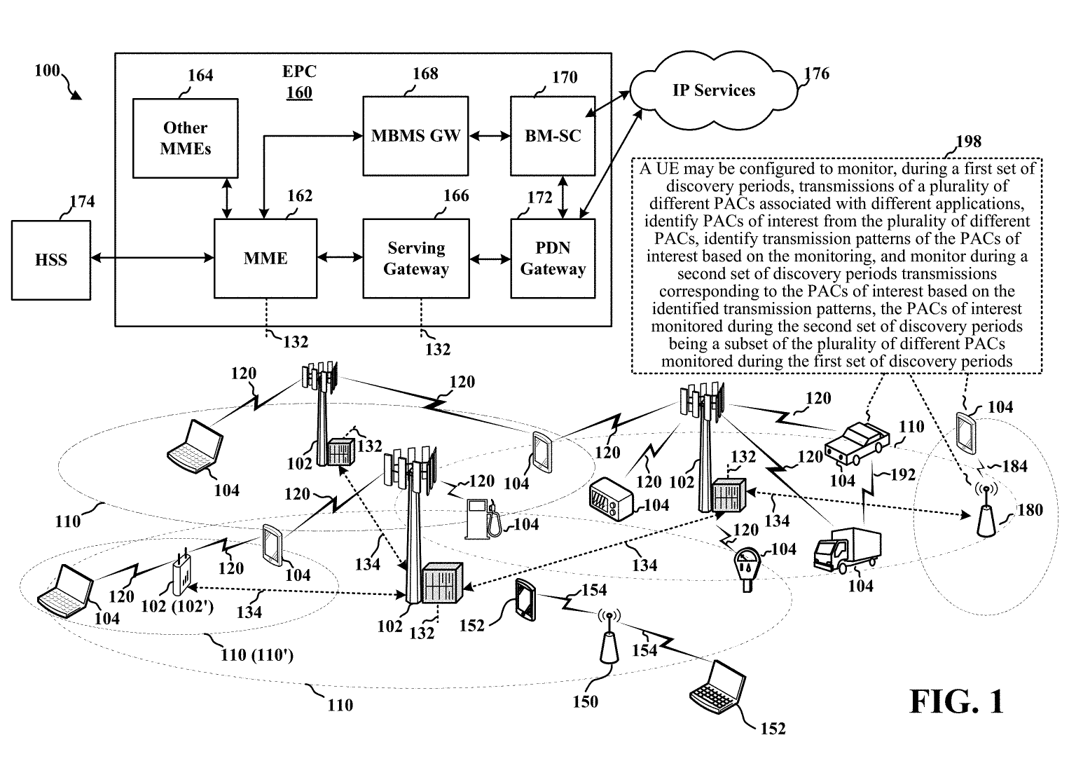

FIG. 1 is a diagram illustrating an example of a wireless communication system and an access network 100. The wireless communication system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., 51 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 192. The D2D communication link 192 may use the DL/UL WWAN spectrum. The D2D communication link 192 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communication systems, such as for example, FlashLinQ, WiMedia, Bluetooth, ZigBee, Wi-Fi based on the IEEE 802.11 standard, LTE, or NR.

The wireless communication system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to monitor, during a first set of discovery periods, transmissions of a plurality of different PACs associated with different applications, identify PACs of interest from the plurality of different PACs, identify transmission patterns of the PACs of interest based on the monitoring performed during the first set of discovery periods, and monitor, during a second set of discovery periods, transmissions corresponding to the PACs of interest based on the identified transmission patterns (198). The PACs of interest monitored during the second set of discovery periods being a subset of the plurality of different PACs monitored during the first set of discovery periods.

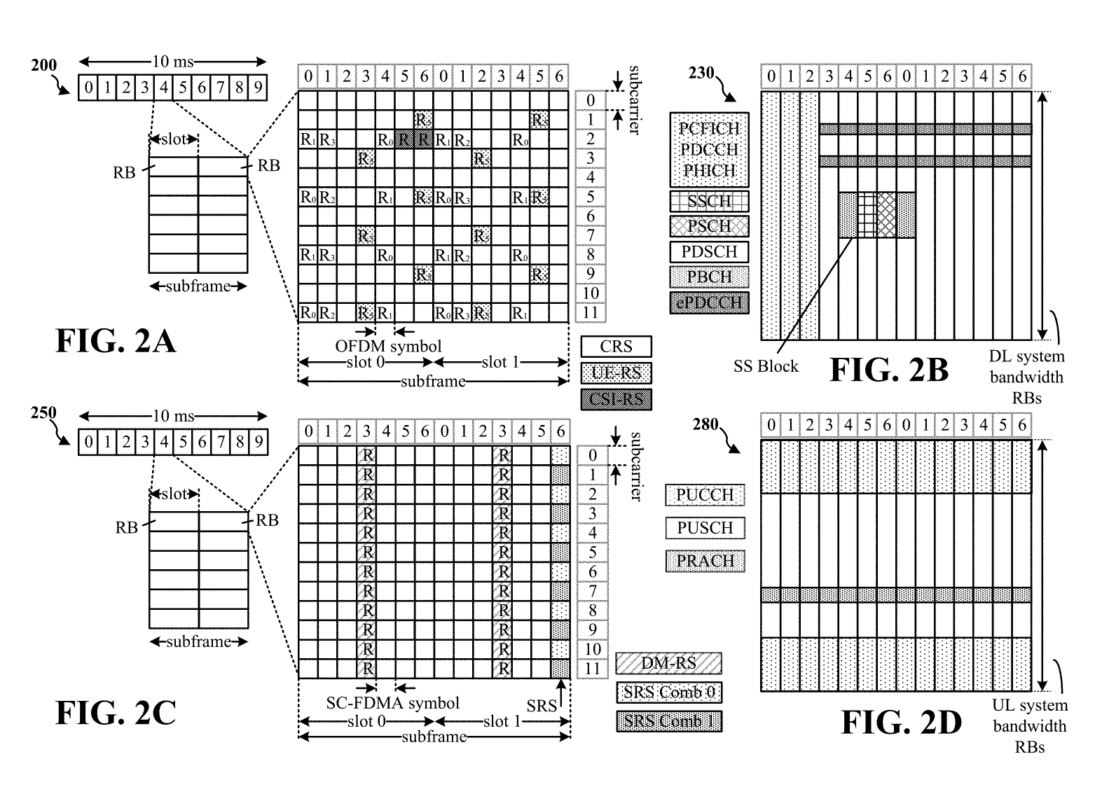

FIG. 2A is a diagram 200 illustrating an example of a DL frame structure. FIG. 2B is a diagram 230 illustrating an example of channels within the DL frame structure. FIG. 2C is a diagram 250 illustrating an example of an UL frame structure. FIG. 2D is a diagram 280 illustrating an example of channels within the UL frame structure. Other wireless communication technologies may have a different frame structure and/or different channels. A frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). For a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

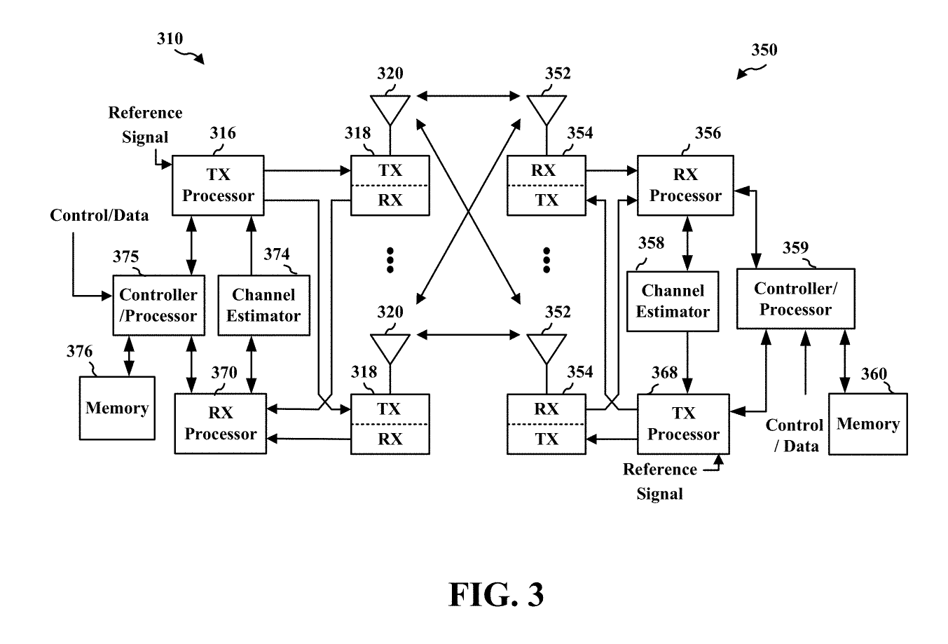

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

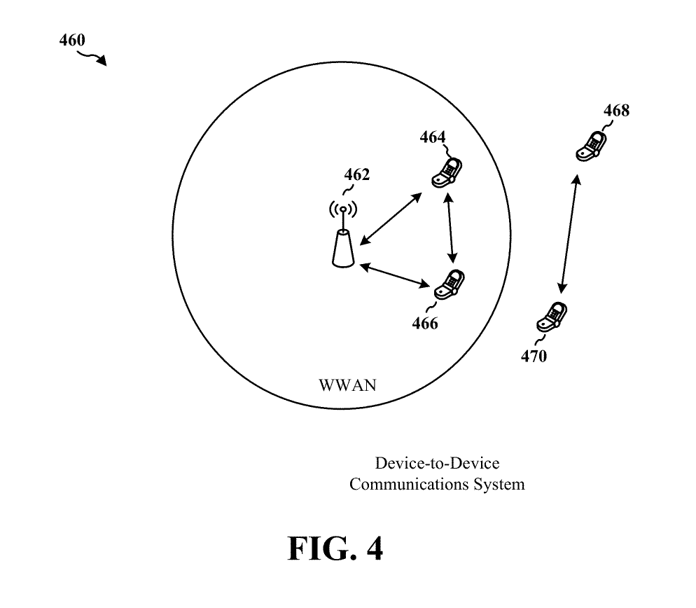

FIG. 4 is a diagram of a device-to-device (D2D) communication system 460. The D2D communication system 460 includes a plurality of UEs 464, 466, 468, 470. The D2D communication system 460 may overlap with a cellular communication system, such as for example, a WWAN. Some of the UEs 464, 466, 468, 470 may communicate together in D2D communication using the DL/UL WWAN spectrum, some may communicate with the base station 462, and some may do both. For example, as shown in FIG. 4, the UEs 468, 470 are in D2D communication and the UEs 464, 466 are in D2D communication. The UEs 464, 466 are also communicating with the base station 462. The D2D communication may be through one or more sidelink channels, e.g., as discussed earlier with regard to D2D communication between UEs through the D2D link 192. The UEs 464, 466, 468, 470 may support proximity service (ProSe) related operations including ProSe discovery mechanisms, e.g., direct discovery.

The exemplary methods and apparatuses discussed infra are applicable to any of a variety of wireless D2D communication systems, such as for example, a wireless device-to-device communication system based on FlashLinQ, WiMedia, Bluetooth, ZigBee, or Wi-Fi based on the IEEE 802.11 standard. To simplify the discussion, the exemplary methods and apparatus are discussed within the context of NR. However, one of ordinary skill in the art would understand that the exemplary methods and apparatuses are applicable more generally to a variety of other wireless device-to-device communication systems.

Owing to the growing popularity of proximity based applications and services, there has been an increased interest in supporting short range communications such as direct D2D communications. For devices to be able to discover applications and/or proximity services (ProSe) in their proximity, many discovery mechanisms (including LTE-Direct (LTE-D) discovery) may be supported in various configurations. In an aspect, UEs may be configured to implement both LTE-D discovery as well as LTE-D communication on sidelinks (e.g., PCS Interface). LTE-D discovery may be used by a UE to monitor/discover the presence of other devices, applications and/or services in the proximity of the UE. LTE-D communication may be used to perform direct, e.g., one on one, communication between devices, e.g., D2D type communication between two UEs.

For LTE-D discovery, a network node, e.g., a base station or another node, may inform the UEs operating in the network about dedicated/shared radio resources, e.g., receive (Rx) and transmit (Tx) pools, to be used for discovery purposes, e.g., using SIB19. For example, the network may indicate up to 16 slots for Rx in the SIB. That is, in a given SIB broadcast from the network, the network may indicate the Rx resources which the operating UEs should monitor (and optionally decode) to discover other devices and/or services. Based on the information in the SIB, e.g., SIB19, the UEs that wish to participate in the discovery may monitor each of the indicated resources. Furthermore, the network may indicate up to 4 slots for transmissions in the SIB, and the UE may select, from the list of Tx slots identified in the SIB, a slot to Tx, e.g., transmit discovery related information. Similarly the information regarding the resource pool for LTE-D communication may be conveyed to the UEs using, for example, SIB18. The Rx slots may include a super-set of all Tx slots in the current cell and Tx slots from neighbor cells.

LTE-D Rx and Tx resources for discovery are defined in a discovery period which may be, e.g., from 32 milliseconds up to 10.24 seconds long (1024 radio frames) in some configurations. SIB18/19 may also have inter-operator PLMN identifiers (IDs) and Evolved Universal Terrestrial Radio Access (E-UTRA) absolute radio-frequency channel numbers (EARFCN) which can be monitored by UEs. In some cases, the UEs may need to read SIB18/19 on selected PLMNs/EARFCNs and identify Rx/Tx slots and use the identified Tx/Rx slots. UEs may need to monitor MIBs on each EARFCN to identify any changes in SB18/19 so that the information regarding the Rx/Tx resources for LTE-D discovery and/or communication stays updated. LTE-D may be supported in out of coverage areas where LTE-D slots as read from earlier decoded SIB19 or pre-configured slots may be used.

During the discovery periods, some devices may periodically broadcast short bit strings referred to as ProSe application codes (PACs) or expression codes over-the-air, while other devices in proximity to the transmitting device(s) attempt to detect the codes, e.g., by monitoring the resources dedicated for discovery. The devices transmitting the PACs are sometimes referred to as the announcing devices, whereas the devices attempting to receive/detect the codes are referred to as the monitoring devices. The announcing and monitoring devices may include, for example, UEs, fixed and/or mobile access points and a variety of other communication devices. A PAC corresponds to a ProSe application and may be associated with an application-layer (e.g. human-readable) name referred to as a ProSe Application Name. The ProSe Application Name may be a component of a ProSe Application Identifier (PAI). A user may install one or more ProSe applications of interest on the user's UE and may be interested in detecting announcements corresponding to the ProSe applications of interest and/or discovering other UEs with the same applications of interest. There may be a variety of ProSe applications installed on the UE based on the user's interest, e.g., a coffee shop application (e.g., Starbucks), a bookstore app, a public safety related application (e.g., police/fire department) etc. Other users with similar interests may have installed the same or similar types of ProSe applications on the respective users' UEs. A UE may perform discovery during a discovery period to discover an announcement corresponding to a ProSe application of interest in the proximity of the UE and/or discover another UE with the same application of interest.

A LTE-D capable device may monitor and decode data on all Rx resources, e.g., sets of PRBs/subframe combinations (e.g., specified in SIB19) of a discovery period to discover PAC transmissions corresponding to various ProSe applications. For example, a monitoring UE that desires to participate in discovery may monitor all time-frequency resources (e.g., specified in SIB19) for PAC transmissions corresponding to various ProSe applications and may filter out PACs corresponding to applications of interest. Such a blind monitoring of all discovery resources may be performed without knowing a number of users (in the proximity of the monitoring UE) interested in the same ProSe applications and may be wasteful in terms of power spent to monitor all PAC transmissions in the discovery resources. Moreover, most of the ProSe applications follow a static transmission pattern, e.g., with the PACs corresponding to the ProSe applications being transmitted in the same subframes/slots of periodically repeating discovery periods. While possible, it may be rare or infrequent that a PAC transmission corresponding to a ProSe application changes time-frequency resources over time. Since a monitoring device may need to stay awake to monitor all discovery resources, the device's modem stays powered on during all corresponding subframes/slots which may result in the monitoring device consuming a large amount of power and/or inefficiently consuming power.

Various features related to reducing and/or minimizing power usage in D2D capable devices (e.g., LTE-D capable UEs) due to blind monitoring of all D2D discovery resources in a discovery period, are described. In accordance with an aspect of the disclosure, a learning based intelligent approach to monitor a limited number of time-frequency resources, e.g., a set of PRB/subframe combinations, during the discovery periods may be used. In an aspect, a device may monitor discovery resources to learn/identify transmission patterns for different ProSe applications of interest (e.g., installed on the device) over a period of time. The period of time over which the learning may be performed may include one or multiple discovery periods. In some configurations, the learning based approach may be used in combination with a network feedback approach to further increase power savings during a discovery period. For example, in some configurations, the monitoring device may interact with a network device, e.g., a ProSe application server (also referred to as ProSe server), to obtain the number of registered/active users, for one or more ProSe applications that are of interest to the monitoring device, in the proximity of the monitoring device. The monitoring device may then monitor only a limited number of slots/subframes during the discovery period based on the identified transmission patterns for the PACs of interest and the number of active users for the ProSe applications of interest in the proximity of the user.

The ProSe server may maintain a location based database including information indicating how many active users/UEs are available in a geographic area for each ProSe application of a plurality of ProSe applications. For example, the database may store such information on a per ProSe application and geographic area/region basis, and the information may be updated in the database periodically, e.g., based on location updates from UEs which change locations. Based on the information in the database, the ProSe server may provide a feedback to a querying UE as to how many active users corresponding to one or more ProSe applications (for which the information is requested) are in the proximity of the querying UE. Based on the feedback indicating the number of active users associated with each of the applications in proximity of the monitoring device, the monitoring may be further limited to monitoring subframes and resources in the discovery period, e.g., by monitoring only in subframes and resources in which PACs associated with applications for which the number of active users in the proximity of the monitoring device is above a threshold.

A user having a given ProSe application installed on his/her UE may be considered to be interested in the given ProSe application and/or an active user corresponding to the given application. As an example, a first UE having an installed Starbucks ProSe application may be considered an active user of the Starbucks ProSe application and the UE may monitor during discovery periods for PAC announcements associated with the Starbucks application. Based on location updates from various devices with installed ProSe applications, the ProSe server may identify how many active users for a given ProSe application are located in a given area at a given time, and provide such information to a querying device as discussed above.

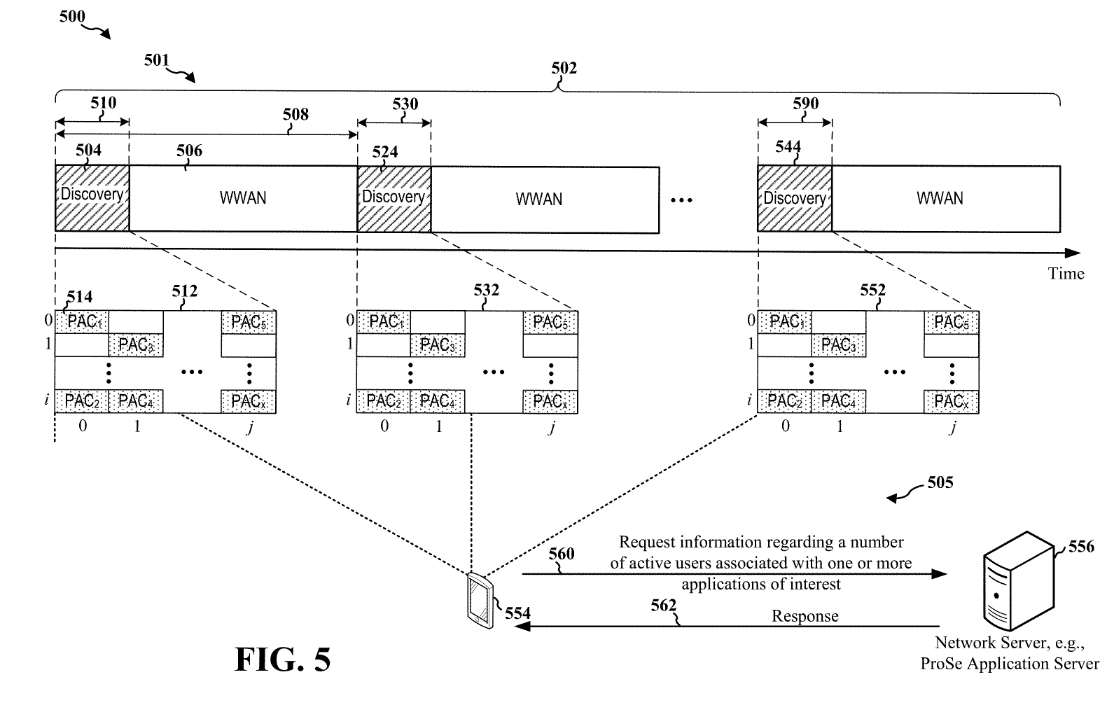

FIG. 5 is a drawing 500 illustrating a recurring time-frequency resource structure 501 which may be used in an exemplary communication system 505, e.g., by devices performing discovery. In the illustrated time-frequency resource structure 501, the vertical axis represents frequency while the horizontal axis represents time. The communication system 505 may be a part of the D2D communication system 460 or may be implemented as an separate D2D network. The time-frequency resources shown in FIG. 5 may correspond to an uplink channel. The uplink channel may have some resources allocated for use in discovery, e.g., LTE-D discovery and/or ProSe discovery. For example the time-frequency resource structure 501 includes a set of resources 502 which are periodically allocated for device discovery and for WWAN communications. For example, during the period 508, portion 504 of the set of resources 502 is allocated for device discovery and a portion 506 of the set of resources 502 is allocated for WWAN. The time period corresponding to duration 510 may be a discovery period and the portion 504 of the set of resources 502 may include time-frequency resources for discovery, e.g., LTE-D discovery resources. During the discovery period 510, various announcing entities may broadcast PACs while the monitoring devices, e.g., UE 554, monitor the discovery resources to detect the PACs. In some configurations, the duration of discovery period 510 corresponding to portion 504 may be from 32 milliseconds to 10 seconds. In one configuration, each of the discovery periods 510, 530, . . . , 590 (corresponding to portion 504, 524, . . . , 544) may be 64ms. As shown in FIG. 5, each portion of the set of resources 502 allocated for discovery may include a subset of resources. For example, portion 504 corresponding to the discovery period 510 allocated for device discovery may include a subset of resources 512. The subset of resources 512 in some configurations, may include/ subframes, where each of the j subframes includes i sets of subcarriers. The subset of resources 512 may be divided in terms of discovery resources such that the subset of resources 512 may include k discovery resources, e.g., where each small rectangle 514 within the block 512 indicates a single discovery resource. In an aspect, each discovery resource may correspond to a set of subcarriers and one subframe. Thus, in such an aspect a set of subcarriers in a subframe may be defined as a single discovery resource, such as discovery resource 514. In some configurations, each set of subcarriers may include 12 contiguous subcarriers. In some such configurations, each discovery resource may include two contiguous/consecutive (in time) PRBs.

In an aspect, a device/entity may use a single discovery resource (e.g., discovery resource 514) for transmissions associated with discovery. For example, in some configurations, a device may use a single discovery resource (e.g., resource 514) to transmit one PAC (e.g., PAC₁). In some configurations, the device/entity may be allowed to transmit one PAC in a subframe, i.e., the same device/entity may not transmit the same PAC in a different discovery resource corresponding to the same subframe. However, a same PAC may be transmitted more than once in a discovery period, e.g., using an allocated discovery resource corresponding to a different subframe. Thus, different announcing devices/entities may transmit PACs associated with different ProSe applications in different discovery resources of the discovery period. For example, as illustrated in drawing 500, in the discovery period 510, PAC₁ (e.g., associated with a first ProSe application) may be transmitted in a first discovery resource, PAC₂ (e.g., associated with a second ProSe application) may be transmitted in a second discovery resource, PAC₃ (e.g., associated with a third ProSe application) may be transmitted in a third discovery resource, PAC₄ (e.g., associated with a fourth ProSe application) may be transmitted in a fourth discovery resource, PAC₅ (e.g., associated with a fifth ProSe application) may be transmitted in a fifth discovery resource, . . . , and PACX (e.g., associated with a X^{th} ProSe application) may be transmitted in a K^{th} discovery resource. As briefly discussed earlier, generally the PACs may follow a static transmission pattern, e.g., the PAC corresponding to a ProSe application is transmitted in the same discovery resource/subframe of the periodically repeating discovery periods 510, 530, . . . , 590 (corresponding to discovery resource portions 504, 524 . . . , 544 of the set of resources 502). Thus as illustrated in FIG. 5, in the next discovery period 530 (corresponding to portion 524 and the subset of resources 532), the PAC transmissions (e.g., PAC₁, PAC₂, . . . , PACₓ) may repeat in the same subframes as in the previous discovery period 510. As such, while possible, a PAC transmission may not change time-frequency resources over time. However, in some aspects the PAC transmission may change time-frequency resources over time.

The communication system 505 includes the UE 554 and a network server, e.g., a ProSe application server 556, and uses the time-frequency structure 501. The communication system 505 may have additional elements such as elements illustrated in FIG. 1 and described earlier. Furthermore, while PAC transmissions associated with various applications are illustrated, the entities, e.g., devices, transmitting the PACs are not shown. The UE 554 may participate in a discovery process to discover PACs associated with ProSe applications of interest, e.g., ProSe applications which are of interest to a user of the UE 554 and which may be installed on UE 554. Thus the UE 554 may monitor the discovery period resources for PAC transmissions.

In accordance with an aspect, to improve power efficiency in monitoring, the monitoring UE 554 may first monitor during a first set of discovery time periods (e.g., one or more of the discovery periods 510, 530, . . . , 590) transmissions of a plurality of different PACs associated with different applications to learn and/or identify the transmission patterns of the different PACs. This may be referred to as a learning phase where the UE may perform monitoring on all discovery resources and/or subframes (e.g., as indicated in SIB19 from a serving base station such as base station 462). For example, the first set of discovery periods may include the discovery periods 510 and 530. Based on received SIB information, the UE 554 may determine the resources and/or subframes (in the discovery periods 510 and 530) the UE 554 should monitor to discover transmitted PACs. Then the UE 554 may perform monitoring of all such discovery resources and/or corresponding subframes in the discovery periods 510 and 530. The UE 554 may receive all PAC transmissions (e.g., in the discovery periods 510 and 530) and learn/identify the transmission patterns of the various transmitted PACs. For example, from the monitoring performed during the first set of discovery periods, the UE 554 may be able to identify in which discovery resource and subframe each of the discovered PACs (e.g., PAC₁, PAC₂, . . . , PACₓ) was transmitted. While the UE 554 may discover all the PACs transmitted in the first set of discovery periods, the UE 554 may not be interested in all of the ProSe applications corresponding to the detected PACs.

The UE 554 may then identify the PACs of interest among the discovered PACs, e.g., based on known/stored information identifying the PACs associated with applications of interest installed on the UE 554. For example, PACs of interest may include the PACs associated with ProSe applications of interest that are installed on the device and such PACs may be stored, e.g., in association with the installed application, on the UE 554. By monitoring all PAC transmission during the first set of discovery periods and based on the known PACs of interest, the UE may be able to identify if any PAC of interest is discovered among the PAC₁, PAC₂, . . . , PACₓ discovered during the first set of discovery periods. For example, among the discovered PACs, PAC₁ and PAC₃ may correspond to ProSe applications that are of interest to the UE 554 (e.g., installed on the UE 554). In accordance with one aspect, the UE 554 may be configured to identify transmission patterns of the PACs of interest, e.g., to limit monitoring in the discovery periods to resources and/or subframes where these PACs of interested are transmitted. For example, based on the learning during the first set of discovery periods and having identified the transmission patterns of the PACs of interest (e.g., PAC₁ and PAC₃), the UE 554 knows in which resources and/or subframes the PACs of interest are transmitted by the announcing entities. Given the static transmission patterns followed by the PACs, the UE may conclude that PACs of interest may be transmitted in the same subframes of subsequent discovery periods. Thus in some configurations, based on the identified transmission patterns for the PACs of interest, the UE 554 may only monitor or wake up during time periods corresponding to the corresponding subframes in one or more subsequent discovery periods, e.g., a second set of discovery periods following the first set of discovery periods.

In certain aspects, the UE 554 may be only interested in discovering PACs associated with applications of interest for which there is a large number of active users in the geographic proximity of the UE 554. In accordance with an aspect, in addition to learning the transmission patterns for the PACs of interest and limiting the monitoring of discovery resources based on the identified transmission patterns of the PACs of interest, in some configurations the UE 554 may request information regarding a number of active users in proximity of the UE 554 who are interested in the same ProSe applications as the UE 554. For example, there may be other users in the proximity of UE 554 with similar interests who may have installed one or more of the same ProSe applications on their devices as installed on the UE 554. Such users may be considered to be associated with the same ProSe applications of interest as the UE 554. In the context of proximity based applications and services, it may be of interest to the user of UE 554 to discover such other users who are interested in the same types of ProSe applications as the user of UE 554. In an aspect, information regarding a number of such active users associated with the applications of interest may be requested and obtained from the network server 556. For example, the UE 554 may send a request 560 requesting information indicating a number of active users (in the proximity of the UE) associated with one or more of the applications of interest. The request may include a location/position of the UE 554 and may identify one or more applications of interest for which the number of active users for each application is sought.

The UE 554 and other ProSe UEs in the system 505 may register with the network server 556 (e.g., ProSe application server) for one or more applications of interest (and/or services of interest). The UE 554 and other ProSe Ues may each periodically provide updates regarding location and/or any change in applications/services of interest. The ProSe application server 556 thus knows which ProSe applications and/or services are of interest to each UE, and is further aware of each UE's location. The ProSe application server 556 may maintain a database (internal or external) including information indicating how many active users/UEs are available in a geographic area for various ProSe applications. For example, various devices with various different installed ProSe applications may be registered with the network server 556 and each device provides location updates to the network server 556. The network server 556 may store information in the database for each of the registered users/devices. For example, the information in the database may indicate for each device, device identity (e.g., UE identifier), identifiers of installed ProSe applications (which are considered applications of interest for the given device) and current location of the device. Based on the information in the database, the ProSe server 556 may provide a feedback/response 562 to the UE 554 indicating the number of active users (associated with the one or more ProSe applications for which the information is requested) in the proximity of the UE 554. In an aspect, based on the feedback 562, the UE 554 may further limit monitoring to fewer subframes in the subsequent discovery periods (after the first set of discovery periods). For example, for a given ProSe application of interest the UE 554 may compare the number of active users of the ProSe application in the proximity of UE 554 indicated in the feedback/response 562, with a threshold number. If for the given ProSe application of interest the number of active users satisfies the threshold number (e.g., is greater than the threshold number), the UE 554 may perform monitoring for the PAC associated with the given ProSe application in the subframes in which the PAC is transmitted, e.g., based on the knowledge of the transmission pattern for the particular PAC. On the other hand, if for the given ProSe application of interest the number of active users does not satisfy the threshold number (e.g., is less than the threshold number), in accordance with an aspect the UE 554 may decide to ignore monitoring for the PAC associated with the corresponding to the application of interest and not wake up for monitoring in the subframes where the PAC is transmitted. This approach allows further reduction in power consumption for the monitoring UE 554 by further reducing the power spent in monitoring during the discovery periods as discussed above. In some configurations, the threshold number may be a predetermined number or may be dynamically configured based on a current state of battery capacity, e.g., remaining charge. Also, it may be appreciated that monitoring for announcements corresponding to applications of interest for which the number of active users is large (in contrast to those with less number of users in the proximity of the monitoring UE) is more appropriate since with a larger number of users with the same applications/services of interest, there may be a greater likelihood for direct (e.g., D2D) communication opportunities and/or proximity service opportunities.

In some configurations the learning action during which the transmission patterns of PACs of interest are identified may be periodically or non-periodically (e.g., as desired basis) repeated. Based on the repeated learning during one or more discovery periods, the monitoring performed during a subsequent set of discovery periods may be adjusted for power savings in the same manner as discussed above. In some configurations, there may be a one to one correspondence between a ProSe application and PAC, e.g., a given ProSe application may be associated with a corresponding PAC.

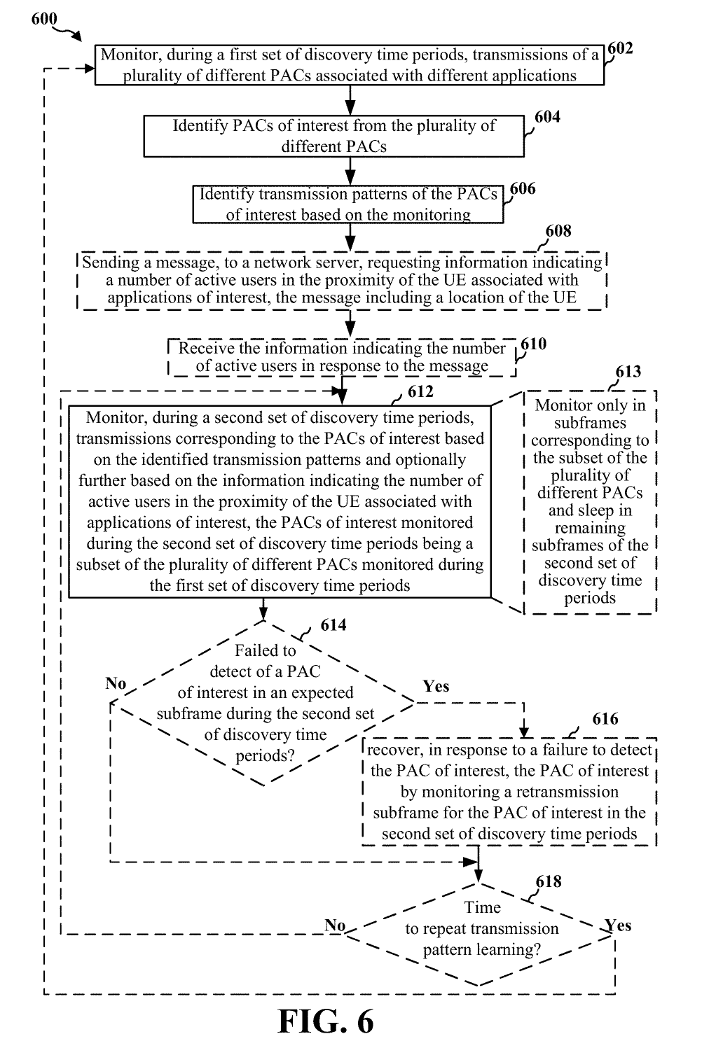

FIG. 6 is a flowchart 600 of an exemplary method of wireless communication in accordance with an aspect. The method of flowchart 600 may be performed by e.g., UE 554 of the communication system 505. Some of the operations may be optional as represented by dashed/broken lines. At 602, the UE may monitor, during a first set of discovery periods, transmissions of a plurality of different PACs associated with different applications. For example, referring to FIG. 5, during a learning phase (that corresponds to the first set of discovery periods) the UE 554 may monitor during all subframes/slots allocated for discovery (e.g., as indicated in SIB19 as discovery receive resources/subframes) in the first set of discovery periods to detect PAC transmissions (for PACs associated with any and/or all ProSe applications for which PACs may be transmitted in the discovery period), and learn PAC transmission patterns for such PACs. The first set of discovery periods may include one or more discovery periods 510, 530, etc. In some configurations, a number of discovery periods in the first set of discovery periods is configurable, e.g., number of discovery periods may be selected based on a user input or automatically based on a current battery/charge level of the UE. For example, when the battery is full, a greater number of discovery periods may be included in the first set of discovery periods to allow for PAC transmission pattern learning over a greater number of discovery periods.

At 604, the UE may identify the PACs of interest from the plurality of different PACs. For example, as discussed above with respect to FIG. 5, not all of the different applications for which PACs are detected during the monitoring in the first set of discovery periods, may be of interest to the UE 554. In some configurations, the PACs of interest are associated the one or more ProSe applications of interest, e.g., applications installed on the UE. As an example, the user may have installed one or more ProSe applications of services/merchandise of interest on the UE, such as, application for a coffee shop (e.g., Starbucks application), fast food store (e.g., McDonalds application), a book store (e.g., Barnes & Noble) etc. In this example, the installed applications may be considered to be the applications of interest and PACs corresponding to such application may also be known to the UE or otherwise stored on the UE in association with the applications. For example, PACs corresponding to the ProSe applications of interest may be obtained by the UE from a network node such as a ProSe function that provides a variety of network services related to ProSe. Thus, based on the applications of interest and the information of the associated PACs, the UE may identify the PACs of interest (if any) from the plurality of different PACs detected during the monitoring in the first set of discovery periods. For example, the UE may compare each detected PAC with a list of PACs of interest to identify if one or more PACs of interest are transmitted.

At 606, the UE may identify the transmission patterns of the identified PACs of interest, e.g., based on the monitoring performed in the first set of discovery periods and the identified PACs of interest. For example, with reference to FIG. 5, the UE may detect a number of different PAC transmissions (PAC₁, PAC₂, . . . , PACₓ) during the first set of discovery periods and learn each PAC's corresponding transmission pattern. Of the transmission patterns of various PACs discovered during the monitoring, one or more transmission patterns may correspond to PACs of interest (assuming there are one or more PACs of interest among the plurality of discovered PACs). Since the UE has already identified PACs of interest from the PACs discovered during the monitoring (e.g., based on prior knowledge/information regarding the PACs associated with applications of interest as discussed above), the UE may be able to easily identify the transmission patterns of the PACs of interest.

At 608, the UE may send a message, to a network server, requesting information indicating a number of active users associated with each of the applications of interest in the proximity of the UE. For example, referring to FIG. 5, the UE 554 may send a request 560 to the ProSe application server 556 requesting information indicating a number of active users (in the proximity of the UE) associated with one or more of the applications of interest. In some configurations the request may include a location/position of the UE 554 and may identify one or more of the applications of interest for which the number of active users in the proximity of the UE of each application is sought.

At 610, the UE may receive in response to the message, from the network server, the information indicating the number of active users in the proximity of the UE associated with one or more of the applications of interest. For example, again referring to FIG. 5, the information indicating the number of active users (in the proximity of the UE 554) associated with one or more of the applications of interest, e.g., users who may be interested in the same applications and/or may have similar interests, may be provided as a feedback/response 562 to the UE 554 from the ProSe application server 556. As discussed above in detail, the ProSe application server 556 may maintain a database including information that explicitly indicates or can be used to derive a number of active users associated with various ProSe applications (applications for which information is requested may be specified in the message/request 560) at a given location at a given time. Based on the information stored in the database, the network server may respond to the request from the UE and provide the feedback. For example, the feedback may include, for each application of interest for which information is requested, an application ID and a number of active users in the proximity of the UE 554 at the given time. In some configurations, the UE may use the received information to decide how to efficiently perform monitoring during upcoming discovery periods.

At 612, the UE may monitor, during a second set of discovery periods, transmissions corresponding to the PACs of interest based on the identified transmission patterns. The PACs of interest monitored during the second set of discovery periods may be a subset of the plurality of different PACs monitored during the first set of discovery time periods. For example, referring to FIG. 5, the first set of discovery periods may include, e.g., the first discovery period 510 (corresponding to discovery resource portion 504) and the second set of discovery periods may include the second discovery period 530 and one or more subsequent discovery periods, e.g., a third discovery period following the second discovery period. In this example, while the UE 554 may be configured to monitor for all PAC transmissions during the learning phase, e.g., in the first discovery period 510, in an aspect after having learned the transmission patterns corresponding to PACs of interest, during a set of subsequent discovery periods (e.g., second discovery period 530, a third discovery period, . . . , Nth discovery period 590) the UE 554 may only monitor for transmissions of PACs of interest. For example, the UE 554 may only consider applications associated with, e.g., PAC₁ and PAC3as the applications of interest. Based on the learning, the UE 554 may know transmission patterns of PAC₁ and PAC₃, and resources and/or subframes in which the PAC₂ and PAC₃ are transmitted. Thus, in such an example, in the second discovery period the UE 554 may only wake up during the time periods corresponding to the subframes in which PAC₁ and PAC₃ transmissions occur. As can be appreciated, PAC₁ and PAC₃ are only a subset of the plurality of different PACs (e.g., PAC₁, PAC₂, PAC₃, . . . , PACₓ) discovered as a result of monitoring during the first set of discovery periods. In various configurations, as part of the selective monitoring discussed with regard to operation 612, at 613 the UE may monitor only in the subframes corresponding to the subset (e.g., PAC₁ and PAC₃) of the plurality of different PACs while sleeping in the remaining subframes of the second set of discovery periods other than the subframes corresponding to the PACs of interest.

In certain aspect, in addition to being based on the identified transmission patterns of the PACs of interest, the monitoring at 612, may be further based on the information indicating the number of active users in the proximity of the UE associated with one or more of the applications of interest, obtained from the network server as discussed above. In some configurations, based on the obtained feedback (e.g., feedback/response 562), for each of the applications of interest, the UE may compare the number of active users in the proximity of the UE with a threshold, and make a decision on which PACs of interest to monitor based on the comparison. For example, if for a given application of interest the number of active users satisfies the threshold (e.g., is greater than a threshold number), the UE may perform monitoring in the subframes where the PAC associated with the given application of interest. Otherwise the UE may not wake up to monitor the subframes/slots associated with the PAC. As previously discussed, such an approach allows further increase in power savings during the discovery periods by further limiting the monitoring to a fewer subframes/resources in the discovery period, e.g., by monitoring only in subframes in which PACs associated with applications for which the number of active users in the proximity of the monitoring device satisfies (e.g., is above) a threshold. Thus, continuing with the previous example where PAC₁ and PAC₃ correspond to the applications of interest, if the UE determines that the number of active users for the application associated with PAC₁ is greater than the threshold while the number of active users for the application associated with PAC₃ is smaller than the threshold, then in accordance with the aspects discussed above, the UE may perform monitoring in the subframes where PAC₁ is transmitted and sleep during the time periods corresponding to the other subframes in which PACs other than other PAC₁, (e.g., PAC₂, PAC₃, . . . , PACₓ) are transmitted. In some configurations, the second set of discovery periods includes a greater number of discovery periods than the first set of discovery periods. In some configurations, a number of discovery periods in the first and second set of discovery periods is configurable.

While monitoring may be limited to a fewer number of subframes and resources in the above discussed manner, in accordance with an aspect, if an anomaly or irregular/random behavior in PAC transmission pattern is detected while monitoring during the second set of discovery periods, then the use of a HARQ retransmission scheme during the discovery process (e.g., HARQ retransmission in LTE-D discovery) may allow the UE to address/resolve issues that may arise during the discovery process. For example, during the second set of discovery periods the UE may perform monitoring based on the transmission patterns of the PACs of interest in subframes limited to subframes in which PACs of interest may be transmitted. If the UE fails to detect an expected PAC in an expected resource and subframe (in accordance with the learned transmission pattern for the PAC) then the detection failure may be indicative of an irregular PAC transmission behavior. However, use of HARQ retransmission in the discovery periods, may allow the failed PAC transmission to be recovered from a retransmission subframe corresponding to the PAC. At 614, the UE may determine if a PAC of interest (of the one or more PACs of interest) for which monitoring is being performed in the second set of discovery periods in accordance with a transmission pattern for the PAC of interest (e.g., in an expected subframe) failed detection. If it is determined that the PAC of interest failed detection in the expected subframe, e.g., in accordance with the learned transmission pattern for the PAC, then at 616 the UE may recover the PAC of interest by monitoring a retransmission subframe corresponding to the PAC of interest in the second set of discovery periods. A retransmission subframe for a PAC of interest may include a discovery resource allocated for retransmission of the PAC. In some configurations, the discovery resources and/or retransmission subframes allocated for PAC retransmissions within the discovery periods may be indicated in SIB19. In various configurations, as part of learning the transmission patterns corresponding to the PACs of interest during the first set of discovery periods, the UE may also learn the retransmission patterns for the PACs of interest, e.g., by identifying resources and subframes in which the PACs of interest are retransmitted. Based on such learning during the first set of discovery periods, the UE may know in which subframes and set of subcarriers the retransmission of each PAC of the PACs of interest occurs, and use this knowledge in recovering the PAC of interest in case of detection failure. In an aspect, the failure to detect the PAC of interest of the PACs of interest may include detecting a random PAC (which is not in the PACs of interest) in a subframe corresponding to the PAC of interest monitored during the second set of discovery periods. That is, the failure to detect the PAC of interest in the expected subframe corresponding to the PAC of interest may be due to transmission of another random PAC in the subframe corresponding to the PAC of interest. In either case, whether the PAC of interest is missing in the expected subframe or there is another random PAC in place of the PAC of interest, the UE may recover the PAC of interest by waking up to monitor for the PAC retransmission during the retransmission subframe(s).

Referring once again to 614, if the determination at 614 is negative, then the operation may proceed to 618. At 618, the UE may check if it is time to repeat the learning, e.g., learning of transmission patterns of PACs corresponding to various applications. For example, the UE may configured to repeat the learning process as performed in the first set of discovery periods, e.g., repeat periodically or based on a schedule. The periodicity for repeating the learning may be may be set automatically or based on user input. For example, the UE may be configured to repeat the learning (e.g., as discussed above with respect to 602) every 1 hour. In this example, the UE may repeat the operation at block 602 every hour and then proceed to one or more of the operations discussed with respect to blocks 604 through 614. If at 618 it is determined that the it is time to repeat the learning, e.g., by monitoring all PAC transmissions is another set of discovery periods, the operation proceeds from 618 back to 602 as indicated by the loopback arrow. However, if at 618 it is determined that the time to repeat learning has not been reached (e.g., a set timer has not expired), the operation may proceed back to 612 and the limited monitoring during the second set of discovery periods may continue.

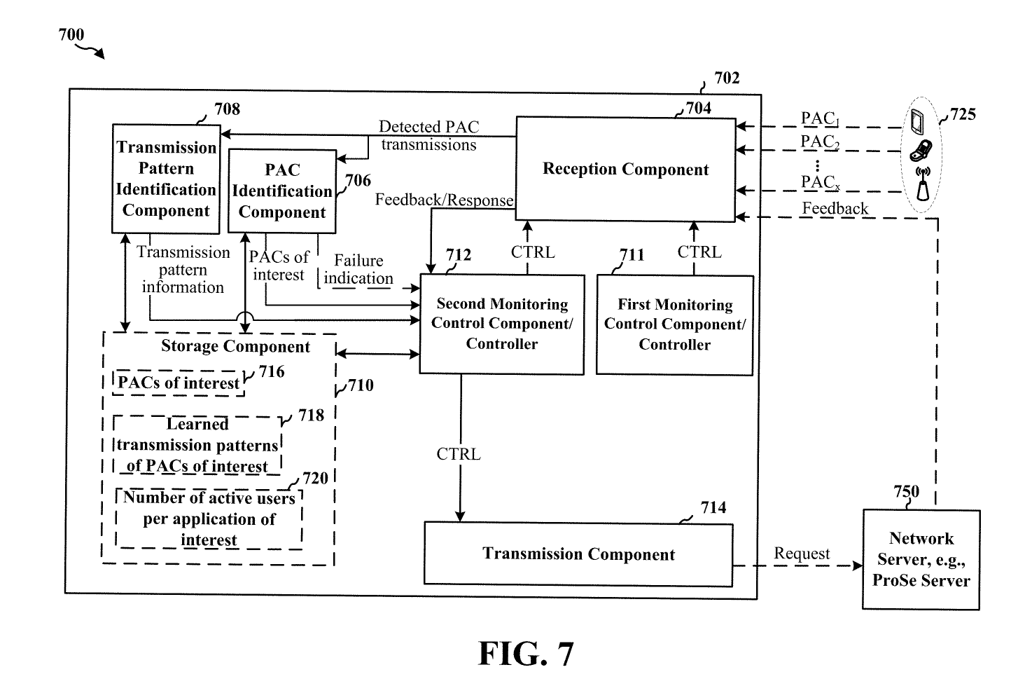

FIG. 7 is a conceptual data flow diagram 700 illustrating the data flow between different means/components in an exemplary apparatus 702 which may be used in a communication system such as system 505. The apparatus may be a UE capable of supporting proximity service related operations, e.g., such as UE 104/350/554 and/or any of the UEs shown in D2D communication system 460. The apparatus 702 may include a reception component 704, a PAC identification component 706, a PAC transmission pattern identification component 708, a storage component 710, a first monitoring control component 711, a second monitoring control component 712, and a transmission component 714.

The reception component 704 may be configured to monitor, receive and process messages and/or information (e.g., PAC announcements) from other devices such as one or more devices collectively shown as PAC transmission entities 725, and/or from the network server 750. In some aspects, the operation of monitoring as described herein may include reception, e.g., receiving. The monitoring may further include processing of a received PAC, e.g., decoding. In some configurations, the reception component 704, alone or in combination with the first monitoring control component/controller 711, may be configured to monitor, during a first set of discovery periods, transmissions of a plurality of different PACs associated with different applications, e.g., ProSe applications. For example, the apparatus 702 may be the UE 554 of the system 505 and the first monitoring control component/controller 711 may be configured to control the reception component 704 to monitor transmissions of the plurality of different PACs associated with different applications during the first set of discovery periods. As discussed in detail with respect to FIGS. 5 and 6, during a learning phase which may correspond to a selected set of discovery periods, e.g., the first set of discovery periods, the apparatus 702 may be configured to perform monitoring for all PAC transmissions in order to learn the transmission patterns of various different PACs (associated with various different applications) transmitted in the first set of discovery periods. In some configurations, the reception component 704 may be further configured to receive, from the network server 750, a feedback including information indicating a number of active users associated with the applications of interest in the proximity of the apparatus. In some configurations, the number of discovery periods in the first set of discovery periods is configurable and may be configured by the first monitoring control component 711 based on a user input specifying a duration of time for which learning is to be performed. Based on the indicated duration of time, a corresponding number of discovery periods for the first set may be selected. In some other configurations, the number of discovery periods in the first set of discovery periods may be selected automatically by the first monitoring control component 711 without user input, e.g., based on a current power/battery level of the apparatus.

The PAC identification component 706 may be configured to identify PACs of interest from the plurality of different PACs detected by the monitoring during the first set of discovery periods. The PACs of interest may be identified from the plurality of different PACs detected during the first set of discovery periods, e.g., based on a comparison of the detected plurality of PACs and the stored information 716 indicating the PACs of interest which may be associated with the applications of interest installed on the apparatus 702. The transmission pattern identification component 708 may be configured to learn transmission patterns of the various PACs of interest based on the monitoring performed during the first set of discovery periods. The transmission pattern identification component 708 may be further configured to identify the transmission patterns of the PACs of interest based on the monitoring performed during the first set of discovery periods. In some configurations, following the identification, the component 708 may store information indicating the learned/identified transmission patterns of the PACs of interest as information 718 in the storage component 710. As the learning is repeated periodically over time, any changes in the transmission patterns of the PACs of interest may be detected and the information 718 may be updated accordingly.

The storage component 710 is, e.g., a memory or a portion of memory, and may store various pieces of information that may be accessed/used by one or more other components of the apparatus 702. For example, in some configurations, the storage component 710 includes information 716 indicating the PACs, e.g., codes/expressions, of interest. The PACs of interest are associated with the applications of interest (which may be installed on the apparatus 702). As discussed above, the learned/identified transmission patterns of the PACs of interest may also be stored in the storage component 710 as information 718. Additionally, in some configurations, the storage component 710 may store information 720 indicating the number of active users associated with the applications of interest in the proximity of the apparatus, received from the network server 750.

In some configurations, the second monitoring control component/controller 712 may be configured to control the reception component 704 to monitor, during a second set of discovery periods, transmissions corresponding to the PACs of interest based on the identified transmission patterns. The PACs of interest monitored during the second set of discovery periods may be a subset of the plurality of different PACs monitored during the first set of discovery periods. For example, the subset of the plurality of different PACs may be the identified PACs of interest. Thus, based on the learning facilitated by the monitoring performed during the first set of discovery periods, the apparatus may perform the limited monitoring during the second set of discovery periods as discussed earlier in more detail In some configurations, the second monitoring component 712 may control the monitoring, during the second set of discovery periods, based on the information obtained from the PAC identification component 706, transmission pattern identification component 708, and the storage component 710. In some configurations, the above discussed limited monitoring may be performed by the reception component 704 alone or in combination with the second monitoring control component 712. In some configurations, the second monitoring control component 712 may be implemented as part of the reception component.

In some configurations, the second monitoring control component 712 may be configured to trigger sending (e.g., via the transmission component) of a request/message to the network server 750 requesting information indicating the number of active users associated with the applications of interest in the proximity of the apparatus. In some such configurations, the reception component may receive the response/feedback including the requested information from the network server 750 as discussed above. The request may include a location (e.g., a current location/position) of the apparatus 702. In some such configurations, the reception component 704 and/or the second monitoring control component 712 may be configured to monitor, during the second set of discovery periods, the transmissions corresponding to the PACs of interest further based on the information in the received response/feedback, e.g., indicating the number of active users associated with the applications of interest in proximity of the apparatus. In some configurations, the reception component 704 and/or the second monitoring control component 712 may be configured to perform the monitoring during the second set of discovery periods, only in subframes corresponding to the subset of the plurality of different PACs. For example, the second monitoring control component 712 may be configured to control the reception component 704 to perform the monitoring during the second set of discovery periods, e.g., only in subframes and/or resources corresponding to the PACs of interest or the monitoring may be further limited to the subframes and/or resources corresponding to the PACs of interest for which the number of active users is greater than a threshold number as discussed earlier in greater detail. In some such configurations, the second monitoring control component 712 may be configured to control the reception component 704 to sleep (e.g., not wake up to monitor) in various remaining subframes of the second set of discovery periods other than the subframes corresponding to the subset of the plurality of different PACs(e.g., those corresponding to the PACs of interest).

In some configurations, the reception component 704 and/or the PAC identification component 706 may be further configured to detect a failure in receiving a PAC of interest of the PACs of interest in accordance with a transmission pattern of the PAC of interest during the second set of discovery periods. For example, the reception component 704 and/or the PAC identification component 706 may be configured to determine if one or more PACs of interest failed detection in their expected subframes which are being monitored during the second set of discovery periods. The failure to detect a PAC of interest may also include detecting a random PAC (e.g., different than the expected PAC of interest) in a subframe corresponding to the PAC of interest monitored during the second set of discovery periods. In the case of determining such a failure, the PAC identification component 706 may provide a failure indication to the second monitoring control component 712. In some configurations, the second monitoring control component 712 and/or the reception component 704 may be configured to recover, in response to the failure to detect the PAC of interest (in the expected resource during a discovery period of the second set of discovery periods), the PAC of interest by monitoring a retransmission subframe corresponding to the PAC of interest in the second set of discovery periods.

In some configurations, the number of discovery periods in the second set of discovery periods is configurable and may be configured by the second monitoring control component 712 based on a user input specifying a duration of time for the selective/limited monitoring should be performed to save power. Based on the indicated duration of time, a corresponding number of discovery periods for the second set may be selected. In some other configurations, the number of discovery periods in the second set of discovery periods may be selected automatically by the second monitoring control component 712 without user input, e.g., based on a current power/battery level of the apparatus.

The transmission component 714 may be configured to transmit messages, e.g., including control information and/or data, to one or more external devices. For example, the transmission component 714 may be configured to transmit the request message requesting the information indicating the number of active users associated with the applications of interest in the proximity of the apparatus. In some configurations, the apparatus 702 may further include a location determination component configured to determine a current location of the apparatus, e.g., based on a Global Positioning System (GPS) signal and/or other location determination mechanism.

The apparatus may include additional components that perform each of the blocks of the algorithm in the aforementioned flowchart of FIG. 6. As such, each block in the aforementioned flowcharts of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

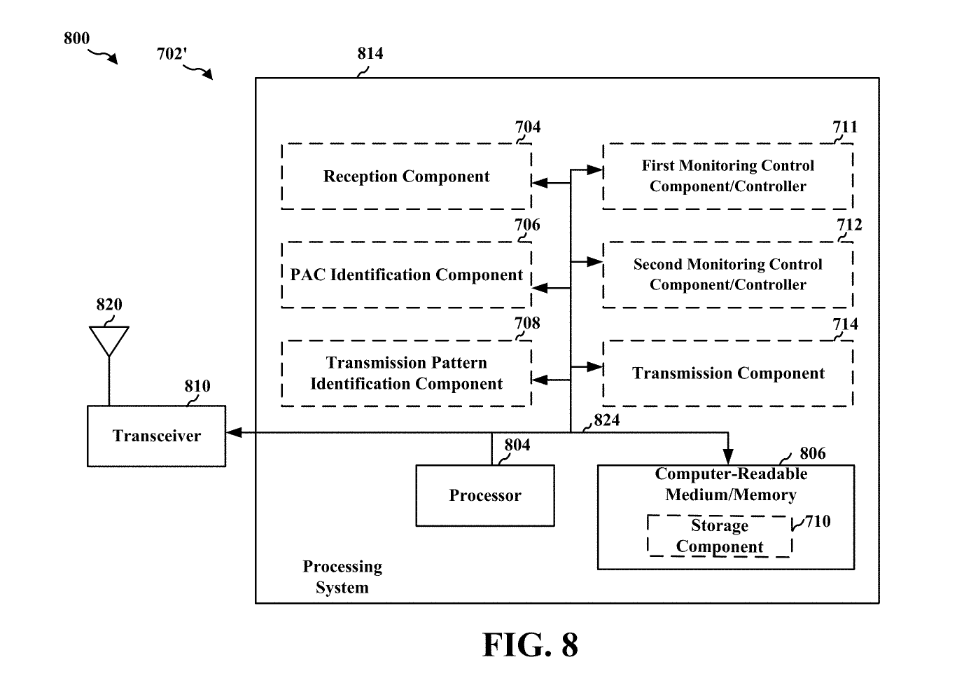

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 711, 712, 714 and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the transmission component 714, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 708, 710, 711, 712, 714. The components may be software components running in the processor 804, resident/stored in the computer readable medium/memory 806, one or more hardware components coupled to the processor 804, or some combination thereof. The processing system 814 may be a component of the UE 350 and may include the memory 360 and/or at least one of the TX processor 368, the RX processor 356, and the controller/processor 359.

In one configuration, the apparatus 702/702′ for wireless communication includes means for monitoring, during a first set of discovery periods, transmissions of a plurality of different PACs associated with different applications. The apparatus 702/702′ may further include means for identifying PACs of interest from the plurality of different PACs, and means for identifying transmission patterns of the PACs of interest based on the monitoring. In some configurations, the apparatus 702/702′ may further include means for monitoring, during a second set of discovery periods, transmissions corresponding to the PACs of interest based on the identified transmission patterns. As discussed earlier in detail, in some configurations, the PACs of interest monitored during the second set of discovery periods are a subset of the plurality of different PACs monitored during the first set of discovery periods.

In some configurations, the PACs of interest are associated with applications of interest. In some configurations, the means for monitoring the transmissions corresponding to the PACs of interest, during the second set of discovery periods, is configured to perform the monitoring further based on information indicating a number of active users associated with the applications of interest in proximity of the apparatus 702/702′. In some configurations, the means for monitoring the transmissions corresponding to the PACs of interest during the second set of discovery periods is configured to perform the monitoring only in subframes corresponding to the subset of the plurality of different PACs. In some such configurations, the means for monitoring the transmissions corresponding to the PACs of interest during the second set of discovery periods is further configured to sleep in remaining subframes of the second set of discovery periods other than the subframes corresponding to the subset of the plurality of different PACs.

In some configurations, the apparatus 702/702′ may further include means for sending a message, to a network server, requesting the information indicating the number of active users associated with the applications of interest in the proximity of the apparatus, the message including a location of the apparatus. The apparatus 702/702′ may further include means for receiving the information indicating the number of active users in response to the message.

In some configurations, the apparatus 702/702′ may further include means for determining a failure to detect a PAC of interest of the PACs of interest in accordance with a transmission pattern of the PAC of interest during the second set of discovery periods. In some configurations, as part of determining a failure to detect a PAC of interest, the means for determining may be configured to determine if a random PAC is detected in a subframe corresponding to the PAC of interest monitored during the second set of discovery periods. In some configurations, the means for monitoring the transmissions corresponding to the PACs of interest during the second set of discovery periods is configured to recover, in response to the failure to detect the PAC of interest, the PAC of interest by monitoring a retransmission subframe corresponding to the PAC of interest in the second set of discovery periods.

The aforementioned means may be one or more of the aforementioned components of the apparatus 702 and/or the processing system 814 of the apparatus 702′ configured to perform the functions recited by the aforementioned means. As described supra, the processing system 814 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

In one configuration, an exemplary apparatus, e.g., apparatus 702/702′, comprises: a memory (e.g., memory 806) and at least one processor (e.g., processor 804) coupled to the memory. The at least one processor may be configured to: monitor, during a first set of discovery periods, transmissions of a plurality of different PACs associated with different applications; identify PACs of interest from the plurality of different PACs; identify transmission patterns of the PACs of interest based on the monitoring; and monitor, during a second set of discovery periods, transmissions corresponding to the PACs of interest based on the identified transmission patterns, the PACs of interest monitored during the second set of discovery periods being a subset of the plurality of different PACs monitored during the first set of discovery periods.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
monitoring, during a first set of discovery periods, transmissions of a plurality of different proximity service (ProSe) application codes (PACs) associated with different applications;
identifying PACs of interest from the plurality of different PACs;
identifying transmission patterns of the PACs of interest based on the monitoring; and
monitoring, during a second set of discovery periods, transmissions corresponding to the PACs of interest based on the identified transmission patterns, the PACs of interest monitored during the second set of discovery periods being a subset of the plurality of different PACs monitored during the first set of discovery periods.

2. The method of claim 1, wherein the PACs of interest are associated with applications of interest, and wherein the monitoring, during the second set of discovery periods, the transmissions corresponding to the PACs of interest is further based on information indicating a number of active users associated with the applications of interest in proximity of the UE.

3. The method of claim 1, wherein the PACs of interest are identified based on applications of interest installed on the UE.

4. The method of claim 1, wherein the monitoring, during the second set of discovery periods, is performed only in subframes corresponding to the subset of the plurality of different PACs.

5. The method of claim 4, further comprising:
sleeping in remaining subframes of the second set of discovery periods other than the subframes corresponding to the subset of the plurality of different PACs.

6. The method of claim 1, wherein the second set of discovery periods includes a greater number of discovery periods than the first set of discovery periods.

7. The method of claim 6, wherein a number of discovery periods in the first set of discovery periods is configurable.

8. The method of claim 2, further comprising:
sending a message, to a network server, requesting the information indicating the number of active users associated with the applications of interest in the proximity of the UE, the message including a location of the UE; and
receiving the information indicating the number of active users in response to the message.

9. The method of claim 1, further comprising:
failing to detect a PAC of interest of the PACs of interest in accordance with a transmission pattern of the PAC of interest during the second set of discovery periods; and
recovering, in response to a failure to detect the PAC of interest, the PAC of interest by monitoring a retransmission subframe corresponding to the PAC of interest in the second set of discovery periods.

10. The method of claim 9, wherein the failing to detect the PAC of interest of the PACs of interest comprises detecting a random PAC in a subframe corresponding to the PAC of interest monitored during the second set of discovery periods.

11. An apparatus for wireless communication, comprising:
means for monitoring, during a first set of discovery periods, transmissions of a plurality of different proximity service (ProSe) application codes (PACs) associated with different applications;
means for identifying PACs of interest from the plurality of different PACs;
means for identifying transmission patterns of the PACs of interest based on the monitoring; and
means for monitoring, during a second set of discovery periods, transmissions corresponding to the PACs of interest based on the identified transmission patterns, the PACs of interest monitored during the second set of discovery periods being a subset of the plurality of different PACs monitored during the first set of discovery periods.

12. The apparatus of claim 11, wherein the PACs of interest are associated with applications of interest, and wherein the means for monitoring, during the second set of discovery periods, the transmissions corresponding to the PACs of interest is configured to perform the monitoring further based on information indicating a number of active users associated with the applications of interest in proximity of the apparatus.

13. The apparatus of claim 11, wherein the means for monitoring the transmissions corresponding to the PACs of interest during the second set of discovery periods is configured to perform the monitoring in subframes corresponding to the subset of the plurality of different PACs.

14. The apparatus of claim 13, wherein the means for monitoring the transmissions corresponding to the PACs of interest during the second set of discovery periods is further configured to sleep in remaining subframes of the second set of discovery periods other than the subframes corresponding to the subset of the plurality of different PACs.

15. The apparatus of claim 12, further comprising:
means for sending a message, to a network server, requesting the information indicating the number of active users associated with the applications of interest in the proximity of the apparatus, the message including a location of the apparatus; and
means for receiving the information indicating the number of active users in response to the message.

16. The apparatus of claim 11, further comprising:
means for determining a failure to detect a PAC of interest of the PACs of interest in accordance with a transmission pattern of the PAC of interest during the second set of discovery periods; and
wherein the means for monitoring the transmissions corresponding to the PACs of interest during the second set of discovery periods is configured to recover, in response to the failure to detect the PAC of interest, the PAC of interest by monitoring a retransmission subframe corresponding to the PAC of interest in the second set of discovery periods.

17. The apparatus of claim 16, wherein the means for determining is configured to determine if a random PAC is detected in a subframe corresponding to the PAC of interest monitored during the second set of discovery periods.

18. An apparatus for wireless communication, comprising:
a memory; and
at least one processor coupled to the memory and configured to:
monitor, during a first set of discovery periods, transmissions of a plurality of different proximity service (ProSe) application codes (PACs) associated with different applications;
identify PACs of interest from the plurality of different PACs;
identify transmission patterns of the PACs of interest based on the monitoring; and
monitor, during a second set of discovery periods, transmissions corresponding to the PACs of interest based on the identified transmission patterns, the PACs of interest monitored during the second set of discovery periods being a subset of the plurality of different PACs monitored during the first set of discovery periods.

19. The apparatus of claim 18, wherein the PACs of interest are associated with applications of interest, and wherein the at least one processor is further configured to monitor, during the second set of discovery periods, the transmissions corresponding to the PACs of interest further based on information indicating a number of active users associated with the applications of interest in proximity of the UE.

20. The apparatus of claim 18, wherein the at least one processor is further configured to monitor, during the second set of discovery periods, subframes corresponding to the subset of the plurality of different PACs.
